(19) United States
(12) Patent Application Publication
(10) Pub. No.: US 2009/0125410 A1
(43) Pub. Date: May 14, 2009

(54) Shared calendar system with automated gift giving

(76) Inventor: Eric M. Perlman, Granada Hills, CA (US)

Correspondence Address: JOHN CARR;CARR & ASSOCIATES, 9th FLOOR, 9595 WILSHIRE BLVD., BEVERLY HILLS, CA, 90212, US

(21) Appl. No.: 11/983,277

(22) Filed: Nov. 8, 2007

(51) Int. Cl. G06Q 30/00; G06F 17/30

(52) U.S. Cl. 705/26; 707/9; 707/10; 707/E17.009

(57) ABSTRACT

An electronic calendaring system which allows for one universal calendar to be shared over a wide area network—such as the Internet—between multiple users wherein events are placed on the calendar by individual users and are assigned privacy settings which control whom may view the event. Events placed on the shared calendar can be designated as an “action event” and tied to a scheduled action which is automatically executed. More specifically, when the action date arrives, the system of the present invention will run a set of actions/instructions which have been specifically selected and defined by the user—such as automatically sending an e-mail reminder or text message to another user, e-mailing an on-line greeting card, ordering and shipping a paper card, gift card, flowers or any other goods/services to a designated recipient. In a preferred embodiment, the system includes a “Gift Wizard” feature which gathers, processes and uses important information from each user to compile an accurate and unique profile for each user in order to help users select gifts for other users.

### FIELD OF THE INVENTION

The invention relates to a shared calendar software program. More specifically, the invention relates to a shared calendar software program having a gift giving feature which automatically executes upon occurrence of certain events within the calendar.

### BACKGROUND OF THE INVENTION

Shared calendaring software programs/systems are well known in the art. In most of these prior art systems, multiple users join a shared group under an electronic calendaring system which is stored and shared across a local area network (LAN). Typically, multiple computer terminals are connected to this LAN and each computer has a localized version of the software installed such that all of these terminals have access to the electronic calendaring system.

In a typical application, each user/member will log into the network via one of these computer terminals in order to then gain access to the electronic calendaring system software resident on that terminal. Typically, each user will have his or her individual calendar stored on that computer terminal, which is then pulled up when he/she logs into the system.

In these prior art calendaring systems, users may add events to other user's calendars through the shared system across the network. More specifically, when a user in the group wishes to add an event to the local calendars of other users, a notice is typically sent out to each member of the group advising them of this event and allowing them to accept or reject the event for addition to their own individual calendar. In this way, multiple users in the group each have their own calendar which may include common events which are shared by all members/users on the network.

As explained hereinabove, each member has secured access to their own individual calendar which is resident on their local computer terminal so that they can also put private events on their calendar which are not meant to be shared. In this way, each individual calendar, while having common events, will also have its own unique appearance in accordance with the schedule of each individual user.

One disadvantage to this type of shared calendaring system is that each individual calendar must be stored, retrieved and updated for each individual user on the network. Accordingly, these applications are usually used across a local area network and have limited capacity.

Therefore, what is needed as a shared system which allows for one global calendar, instead of individual calendars, wherein said global calendar can be accessed, viewed and updated by a much larger group across a much larger network, such as the Internet. More specifically, what is needed is a calendaring system in which events are placed on the calendaring system, with each individual event being given a privacy setting such that when the global calendar is viewed, certain events will be visible or invisible to all users, dependent upon the privacy setting associated with that event. In such a system there is no need to store individual calendars for each individual user. Instead, events and their relative privacy settings are stored and then appear on a common global calendar, being visible only to those persons to whom the event pertains based upon its individual privacy setting.

Additionally, current calendaring software applications are only as good as the user. This means that even if an event is listed on a calendar, a user must usually take some steps to ensure that the event is completed. For example, although an individual birthday or holiday may be scheduled on a calendar system, a user must still engage in some activity in order to make sure the event is a success. In the case of a birthday or holiday this often means that a user must take additional steps such as purchasing a gift and/or sending a card in order to complete the event and make it a success.

Therefore, another disadvantage of an electronic calendaring system such as those already known in the art is that the calendar is only beneficial to the user when he or she has access to the network and is able to take the time to then follow-up with the scheduled event or holiday in order to ensure that it is completed in a timely and successful fashion. If the user is not able to get access to the network for one or more days, important events could lapse. More specifically, if an important birthday, anniversary, or holiday (such as National Secretaries Day) were to occur during a period when a user did not have access to his or her electronic calendar the event could simply pass without the user ever knowing.

Accordingly, what is further needed is a way of scheduling for automated activities/processes to be actively completed upon occurrence of any event on the calendar regardless of any user intervention or direction. For example, the automated task of sending a particular gift or card upon occurrence of a birthday or holiday without the need for a user to actively perform this task

### SUMMARY OF THE INVENTION

The invention is for a calendaring system which allows for one universal calendar to be shared over a wide area network—such as the Internet—between multiple users. Unlike prior calendar systems in which each user has his or her own calendar stored locally and which may display shared events, the invention allows for one calendar to be shared and accessed by multiple users over a wide area network. Events are then placed on the calendar by individual users and are assigned privacy settings which control whom may view the event—i.e. to whom the event will be made visible when the shared calendar is accessed. There are several additional features implemented in the shared calendaring system of the present invention.

First, events placed on the shared calendar can be designated as an “action event” by any user to whom the event is visible. An “action event” is an event tied to a scheduled action. The action is automatically executed on an action date that is somehow tied to the event date. The action date can be the actual event date, or any one of several days before or after the event date. When the action date arrives, the system of the present invention will run a set of actions/instructions which have been specifically selected and defined by the user—such as automatically sending an e-mail reminder or text message to another user, e-mailing an on-line greeting card, ordering and shipping a paper card, gift card, flowers or any other goods/services to a designated recipient.

The system includes a “Gift Wizard” feature which performs many functions that help make gift giving, receiving and event management not only easy but effective and efficient. The “Gift Wizard” gathers, processes and uses important information from each user such as age, gender, wish lists, favorites basket, event type and more to compile an accurate and unique profile for each user and each gift giving event. The “Gift Wizard” then uses this information to help users select gifts for other users and to automatically schedule and execute a an action event in the future. Accordingly, the “Gift Wizard” feature of the present invention provides users with an intelligent tool that can make gift giving a more enjoyable experience for the recipient and the giver by providing a fully automated gift and event service that needs minimal or no interaction from the user.

By way of example, if a user is going out of town for business for the month of December and has 14 people scheduled to receive gifts in December (for various birthdays, holidays and/or other events), the user can configure the “Gift Wizard” to select gifts for each of these 14 people upon occurrence of the particular action event/date for which the gift is to be given—i.e. upon occurrence of the birthday or holiday, or any time before such date. Using the “Gift Wizard” feature of the present invention, a user schedules an action event and may either pre-select the particular gift or set a dollar budget for each gift. Later, when each action event is reached, the “Gift Wizard” can select, purchase and have shipped (via an on-line Internet transaction) the particular gift selected or any other gift appropriate to the person for whom the gift is intended and within the specified budget. The “Gift Wizard” can also be configured to perform other specified actions upon occurrence of the event, such as sending an e-mail, an electronic greeting card, an electronic gift card, or the like. Alternatively, the “Gift Wizard” can be configured to send a notice by e-mail to the user and then configured to wait for the user's confirmation—upon receipt of which the process is then automatically and fully executed.

The “Gift Wizard” is also very useful in scheduling automated processes for recurring action events and can be set to select and send gifts for any type of recurring event. Events can be designated as recurring annually, monthly or even weekly. Again, by way of example, a user may set up a recurring action event to send a present to a friend on his birthday every year. Using the “Gift Wizard” of the present invention, the user might set a specified budget for $50 each time this event reoccurs. The “Gift Wizard” will then automatically select, purchase and have shipped- (all via an on-line Internet transaction) an appropriate gift for the friend every year. Using demographic information pertaining to the user such as age, gender, wish lists and past purchase information, the “Gift Wizard” automatically selects an appropriate gift from a plurality or universe of available gifts; and, in this way, every year on the friend's birthday the friend will not only receive a gift on time but it will also be a gift the friend desires. If the user desired it could have the “Gift Wizard” select a gift for this friend's birthday for the next 10 years. This would not only allow the user to be 100% worry free about this action event but also free countless hours of time while effectively delivering desired gifts on time.

### BRIEF DESCRIPTION OF THE DRAWINGS

FIG. 1 illustrates a preferred embodiment for a registration page in accordance with a preferred embodiment of the present invention;

FIG. 2 illustrates a preferred embodiment for a calendar feature in accordance with the present invention;

FIG. 3 shows a preferred embodiment for an event details page for an event in accordance with a preferred embodiment of the shared calendar system of the present invention;

FIG. 4 shows a preferred embodiment for an “Action Runner” page for scheduling/arranging for the particulars of an action which is to occur upon a certain event scheduled on the shared calendar system of the present invention;

FIG. 5 illustrates a preferred embodiment for the “Gift Wizard” feature of the shared calendar system of the present invention;

FIG. 6 illustrates a preferred embodiment for the “Bank Center” feature of the present invention;

FIG. 7 illustrates the MY WALLET budgeting feature of the present invention;

FIG. 8 illustrates a flow chart for using the software of the present invention in order to execute an automated gift giving action event; and

FIG. 9 illustrates an alternate flow chart for using the software of the present invention in order to execute an automated gift giving action event.

### DETAILED DESCRIPTION OF PREFERRED EMBODIMENTS

The invention is for an internet based shared calendar system which allows for one global calendar which can be accessed, viewed and updated by a large group of users, wherein individual events (each having a particular privacy setting) may be placed on the shared calendar such that when the global calendar is viewed, certain events will be visible or invisible to all users, dependent upon the privacy setting associated with that event. In such a system, events and their relative privacy settings are stored and then appear on the common global calendar, being visible only to those persons to whom the event pertains based upon its individual privacy setting.

Additionally, events placed on the shared calendar can be designated as an “action event” by any user to whom the event is visible. An “action event” is a scheduled event on a day or group of days such that when the date scheduled comes to pass, the system of the present invention will automatically run/execute a set of actions/instructions which have been pre-defined by the user—such as automatically sending an e-mail reminder or text message to another user, e-mailing an on-line greeting card, ordering and having shipped to a designated recipient a paper card, a gift certificate/card, flowers or any other goods/services available from a whole host or universe of available items.

The system further includes a “Gift Wizard” feature which performs many functions that help make gift giving, receiving and event management not only easy but effective and efficient. The “Gift Wizard” gathers, processes and uses important demographic information from each user such as age, gender, wish lists, favorites basket, event type and more to compile an accurate and unique profile for each user and each gift giving event. This profile includes a set of search words or terms which are then used by the “Gift Wizard” to search a plurality or universe of available gift items and/or services. More specifically, the “Gift Wizard” uses these words or terms to search meta tags and on-line information associated with goods and services available for purchase on-line in order to help users select gifts for other users and to automatically schedule and execute a gift event in the future. Accordingly, the “Gift Wizard” feature of the present invention provides users with an intelligent tool that can make gift giving a more enjoyable experience for the recipient and the giver by providing a fully automated gift and event service that needs minimal or no interaction from the user.

Registration/Sign Up:

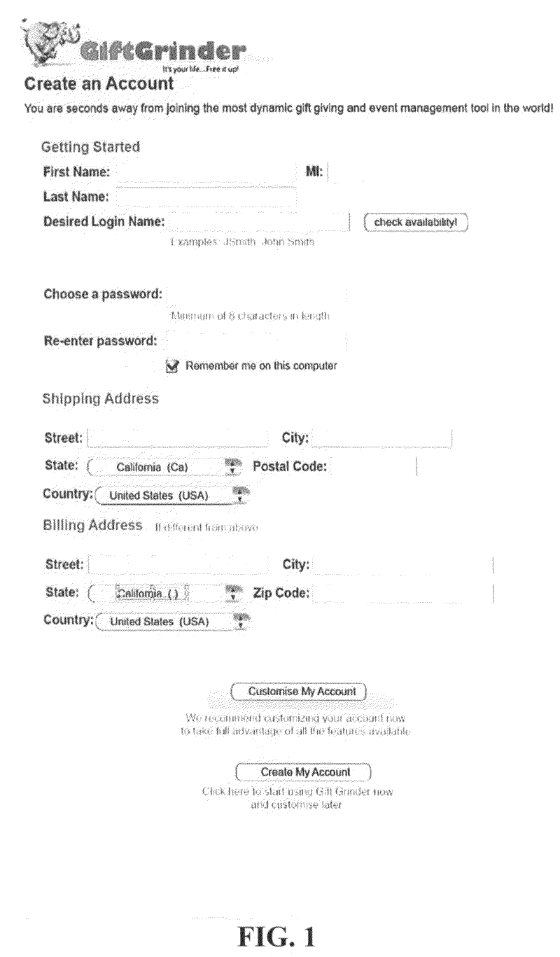

In order to utilize the present invention, a new user will access the http web address start page (i.e. the internet address for the system/software) from any computer with Internet/web access and having a current web browser. The user will then be taken to a “sign up” or registration page, where he/she will enter his/her first and last name and a unique username, password. The user may also be prompted to enter a shipping or residence address (an address where other users might send gifts in accordance with a preferred embodiment of the present invention) and/or a billing address if different from his or her residence/shipping address. FIG. 1 illustrates a preferred embodiment for a registration page in accordance with a preferred embodiment of the present invention.

In a preferred embodiment, a user will have an option of continuing on to another page in order to further customize the user's account. This customization may include entering other personal pertinent information such as his or her e-mail address, alternate mailing addresses and his or her birth date. In a preferred embodiment, when further customizing his or her account a user will also have the option of choosing/selecting from an extensive list of holidays which the user may participate in or celebrate. Once selected by the user, these holidays are stored for future inclusion on the shared calendar when viewed by the user.

After this information is submitted by the user they will receive a confirmation e-mail (sent to the e-mail address the user provided during the “sign up” or registration forum). This confirmation e-mail will provide a hyperlink, which when activated will bring the user back to the internet address where the system/software of the present invention is accessed, thereby confirming the users information and activating the users account—giving the user full access to the tools features of the present invention.

In a preferred embodiment, once a user is registered he or she will have the option to further customize their account (see the account management features described in further detail below) as well as invite other contacts they have—such as friends and family—to join or register by entering their e-mail addresses. The present invention will send all the entered addresses a personalized invitation and a hypertext link inviting them to join and/or register at the account “sign up” or registration page.

The now registered user will have an array of features and tools available including the interactive shared calendar feature, an event management tool referred to hereinafter as the “My Events” feature, an account management tool referred to hereinafter as the “My Account” feature, an “Action Runner” feature, an “Event Details” feature, a “Coupon Center” feature, a “Shipping Center” feature, a “Gift Card Center” feature, a contacts management tool referred to hereinafter as the “Contacts” feature, a “Gift Universe” feature, a “Gift Wizard” feature, an interactive “My Wallet” feature, and a “Gift Points” feature—each of which is described with greater detail further hereinafter.

Shared Calendar

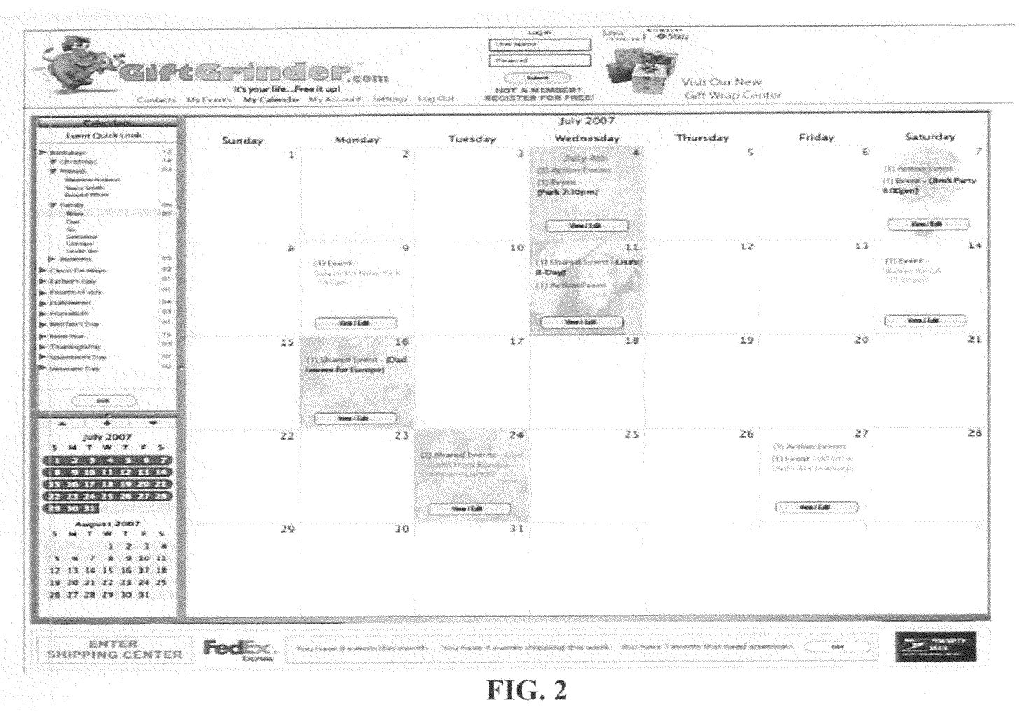

The shared calendar feature is a dynamic feature that is the heart of the present invention. The shared calendar feature of the present invention allows a user to have an interactive visual snapshot of either a day, a month or even a full year and all the “events” and “action events” contained within such time frame. The calendar is dynamic and has many unique features. As explained earlier herein, the calendar is shared across the entire network of registered members and will automatically update in real time to show the latest events as they are added, deleted or changed. The privacy settings within each event will determine what members or group of members, if any, will be able to view the event on the calendar. The calendar will also preferably differentiate between events, action events and shared events from other members by color coding or adding a picture icon to their labels in the calendar. FIG. 2 illustrates a preferred embodiment for a calendar feature in accordance with the present invention.

FIG. 2 illustrates a preferred embodiment of a shared calendar in accordance with a preferred embodiment of the present invention. As shown, the calendar view has been customized for this user and will be displayed when he or she accesses the website/webpage. In short, the calendar is a universal template—either annual, monthly, bi-weekly, weekly and/or daily—which is populated with events made visible to this user based upon privacy settings associated with these events. Accordingly, the calendar shown in FIG. 2 has a number of events, shared events and action events, all of which are visible to this user. For example, on July 4^{th} this user has an event scheduled to remind him/her of an “event” scheduled to take place in the “PARK” at 7:30 pm. Similary, there is a shared event scheduled for Jul. 16, 2007 and two shared events for Jul. 24, 2007.

“Events” are personal to that user and are more like schedule reminders for that user. “Shared Events” are associated with more than one person and will be visible on multiple calendars. As explained earlier, each event has privacy setting so “Events” would be private to that particular user while “Shared Events” are have different privacy settings and may be shared/viewed by multiple users. Finally, the calendar of FIG. 2 also shows an “Action Event” scheduled for Jul. 11, 2007 and three action events scheduled for Jul. 27, 2007. These “Action Events” have their own privacy settings such that they may or may not be visible to other users; but, each action event has a particular action series of automated instructions associated therewith which have been set by the user and which will be automatically executed, as set forth and described in greater detail further hereinafter.

A user can add information to the calendar for any particular date by simply clicking/selecting the interactive “View/Edit” bar which will allow the user to view all the items appearing on that day and to add or remove items from that day. In order to edit the specifics of any particular item, the user would click on that item. More specifically, all of the items which appear on the calendar are actually hyperlinks, allowing a user to one-click on any particular event and automatically navigate to event/action details associated with that particular event via the Event Details feature of the present invention. The Event Details feature of the present invention allows a user to see particular event details about that event.

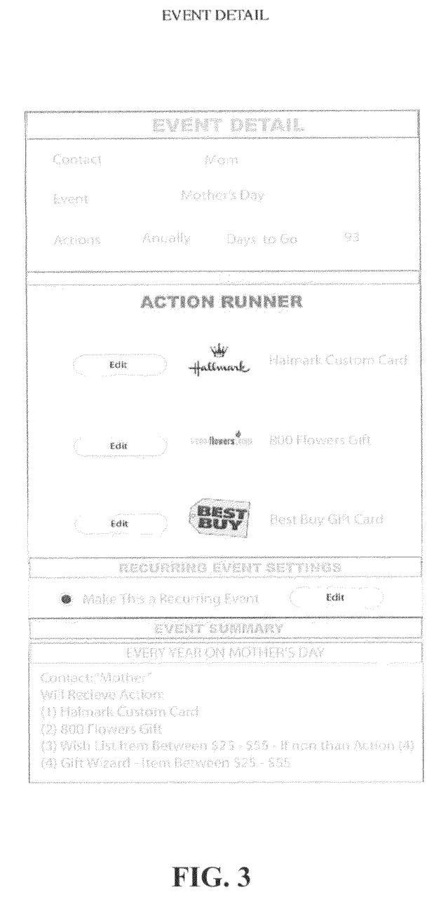

FIG. 3 shows a preferred embodiment for an event details page for an event which appears on the shared calendar system of the present invention. As shown, the event details web page is preferably divided into four sections. A first section is labeled as “EVENT DETAIL” and it shows some basic details associated with the event. More specifically, as shown under FIG. 3, the event is Mother's Day and it is an annual event on which an action is scheduled to occur annually. In a preferred embodiment, this section will also show the number of days remaining until the event occurs. The second section is labeled as “ACTION RUNNER”. This ACTION RUNNER section of the Event Details page will show what actions are currently scheduled to occur along with the event—i.e. what sequence of specialized instructions the user has set up to automatically occur with the event. In this case the user has set up for the automated purchase and shipment (via a series of on-line transactions) of a card from Hallmark, flowers from 1-800Flowers.com, and a BEST BUY gift card. Any one of these events can be edited and/or removed prior to occurrence of the event. The third section of the Events Details page for this event shows that this is a recurring event. As shown a user can edit this setting. Finally, the fourth section provides a summary of the event. As further shown in FIG. 3, a contact from the user's contacts identified as MOTHER will receive gifts as shown. As described later hereinafter, when this action event occurs, the software will automatically execute the instructions and will automatically pull the shipping address, where the above-mentioned goods are to be sent, from the address associated with this contact.

Event Management Tool—“My Events”

The event management tool—sometimes referred to herein as the “My Event” feature—allows a user to create visual events which will be added to the displayed calendar, making these events visible to any other users of the shared calendar the user wishes to have access to this event. In short, a user may specify a particular time, date and year of the event as well as setting the event's privacy settings. The privacy settings allow the event to be seen or not seen by other specific members or groups. When an event and or action event is created the user must select the “privacy settings” for this event. This is done by selecting which group and or individuals will be able to view this event as well. From the privacy pull-down menu the user may select “All” which allows every contact to view this event, “None” which allows only the user to view this event and no other members, “Group” which allows any specific group of members that the user has created or “Member” which allows a single specific member to view the event. An unlimited number of “Group(s)” and or “Member(s)” may be added in the privacy settings for each event.

The “My Events” also allows for specifying the event as a “recurring event”—which allows the user to have this specific event automatically schedule itself on the user's calendar at regular intervals (as specified by the user—i.e. every day, every month or every year). The user can also highly customize the recurring event to be placed on the calendar. For example having the event occur every 4 months in 2007 but skipping November and every 6 months in 2008 but skipping October and terminating January of 2010.

Action Runner

The “Action Runner” feature of the present invention works hand in hand with the interactive Calendar and the My Events feature and allows a user to associate and schedule a detailed sequence of actions or instructions with a particular event, wherein said sequence of events/instructions will be automatically executed upon occurrence of the specific event—i.e. at the specific time and date or dates over the calendar year on which the event is scheduled. The “Action Runner” option is accessed through the “My Events” feature and any event can be turned into an action event by clicking the “Action Runner” option in the event management tool menu.

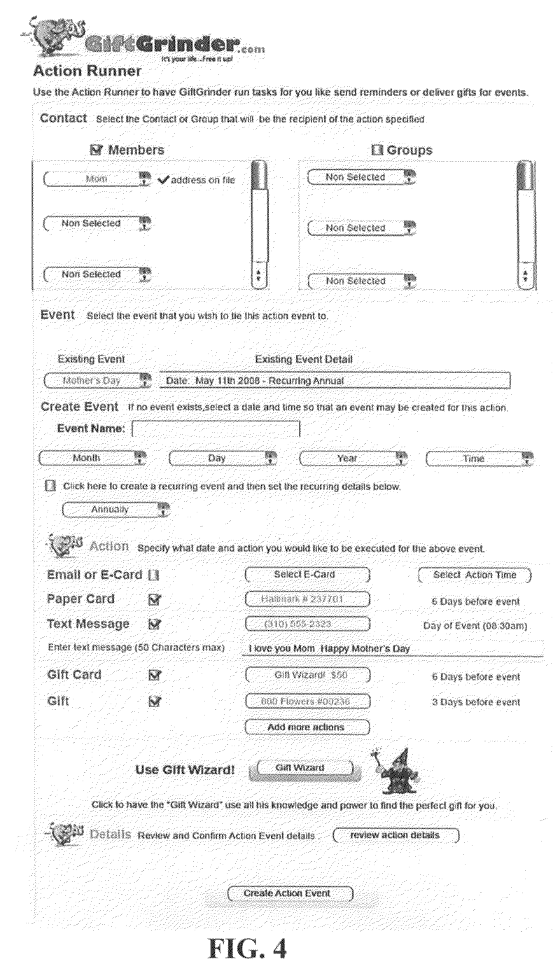

FIG. 4 shows a preferred embodiment for an “Action Runner” page for scheduling/arranging for the particulars of an action which is to occur upon a certain event scheduled on the shared calendar system of the present invention. The Action Runner when activated has three main fields for creating an action event including: Date and Time, Action, and Recipient or Recipients. More specifically, referring to FIG. 4 there is shown a first field or area of an Action Runner page where a user selects the recipient(s) of the particular action. They may be selected individually by selecting certain members, or they may be specified as groups which the user has created in his or her contacts.

Referring still to FIG. 4 the second field or area is shown where the user actually specifies the Event to which the action is to be tied. The user may use preset calendar dates, such as holidays, birthdays or other important dates he or she selected when the account was first opened or the user may specify the specific event by providing an event name, a date on which the event occurs, and a time at which the event occurs. More specifically, this allows the user to specify when the action should take place take by tying the action to a calendar event.

Finally, as shown in FIG. 4 the Action Runner includes a field or area fo specifying specific actions which are to occur and specifying an exact date and time to execute the specific action—such date and time being preferably tied to the occurrence of the event date—i.e. such that the action is scheduled to occur several days before or after the event date. The action is actually an instruction or series of instructions/commands for the software and system of the present invention to automatically perform some task of function upon occurrence of the specified date. For example, if the user has a Mother's Day event in “My Events” and wants to add an action event to have flowers sent to his Mother 7 days before this event because she is leaving town, the user would click the “Action Runner” option in the users Mother's Day event and set the action date 7 days before Mother's Day.

The Action field allows the user to specify the specific action or sequence of events that are to occur upon the scheduled date and time. A user may choose from a host of actions including the automated purchase and scheduled shipment of a gift—such as flowers or a gift card—or the automated download of an e-greeting card. There are a whole host of gifts available including a Gift Universe, and Wish Lists, which are described in further detail hereinafter. The recipient field allows the user to specify the recipient. This may be done by entering a specific address or by selecting a name and address stored under the user's contacts. By way of example, if a user wished to send a flower product to his mother two days before Mother's Day he may specify the date and time for purchase and shipment of the flower product, he may also select a specific flower product from a whole host of products featured in an available Gift Universe (alternatively, and as will be further elaborated upon hereinafter, the user may use an automated Gift Wizard feature to have a gift automatically selected, purchased and shipped), and he then either selects his mother from his “Contacts” pull down menu (assuming her name and address are in his Contacts) or he may enter a specific name and address where this gift will be sent.

In the example shown in FIG. 4 a user has set up several actions, all of which are tied to the event on the calendar which is Mother's Day. These include, the automated purchase and sending of a gift card from Best Buy in the amount of $50 to occur six (6) days before the event, the automated purchase and shipment of flowers from 1-800-FLOWERS™ (bouquet or item no. 00236) to occur three (3) days before the event, the sending of a text message to cell phone number (310) 555-2323 to occur on the day of the event at 8:30 a.m., etc.

As described herein earlier, if the user wants, there is an additional option in the “Action Runner” which allows a user to utilize a “Gift Wizard”—which will automatically select the gift for the user upon occurrence of this event, or on future events if the event is recurring. The Action Runner also allows the user to access a recipient's “Wish List” (if recipient is also a member within the network of user's having access to the system of the present invention). The Action Runner can then be used to have the action event automatically select a gift for the action from the user's Wish List within certain parameters—i.e. within a certain price range.

Again, it is important to note than an “Action” can be the scheduling of one action or a series or sequence of events/instructions which should occur and these range from sending a simple text message, e-mail card or paper mail card to ordering any type of gift card or gift from thousands of goods and services available via the Internet from select vendors.

Gift Wizard

The “Gift Wizard” feature is a user assistant that performs many automated functions that help make gift giving, receiving and event management not only easy but effective and efficient. The “Gift Wizard” gathers, processes and uses important information from each user such as age, gender, Wish Lists, a Favorites basket, and information regarding a specific event type to compile an accurate and unique profile for each user.

The “Gift Wizard” uses this information to help users select gifts for other users or to automatically select and process a gift event in the future. Accordingly, utilizing the present invention users will have an intelligent tool that can make gift giving a more enjoyable experience not only for the recipient and the giver by providing a fully automated gift and event service that needs minimal or no interaction from the user.

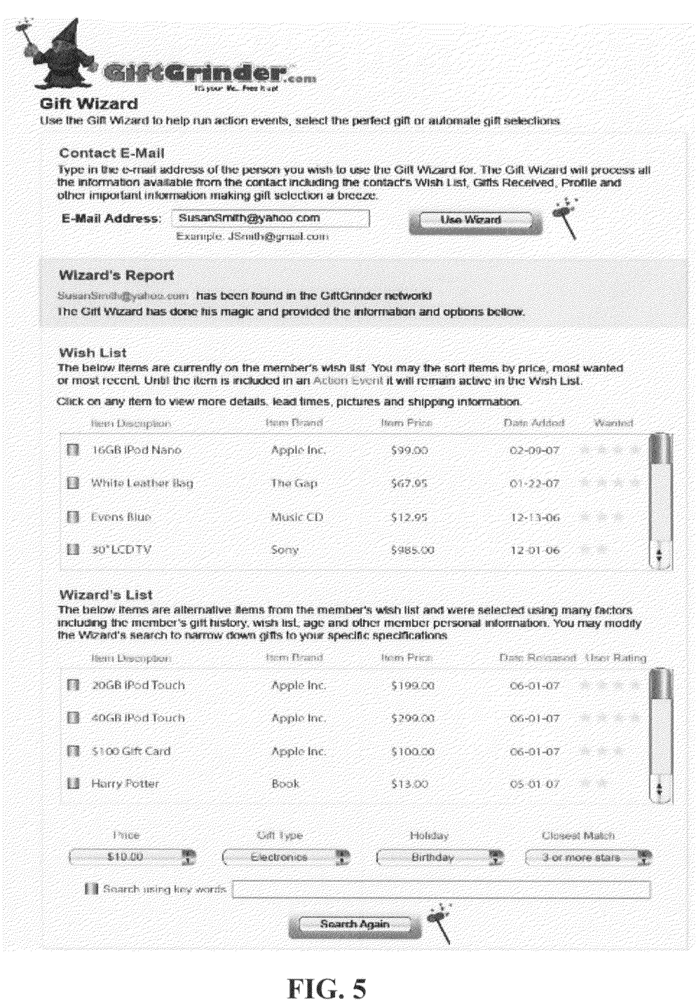

FIG. 5 illustrates a preferred embodiment for the “Gift Wizard” feature of the shared calendar system of the present invention. As shown, the “Gift Wizard” allows a user to enter an e-mail address of an intended recipient of a gift and the invention will then search its database of registered users for a match. Once it locates a matching e-mail the Gift Wizard displays that user's wish list which is comprised of a listing of items that user has added or placed on a wish list so that others might be able to provide a gift for that user more easily.

In a preferred embodiment, the Gift Wizard will also display a suggested Wizard List of gifts that have also been selected for that user based upon items which appear on that user's wish list and personal information entered by the user such as his/her age, gender, other gifts previously purchased for that user by other users. In a preferred embodiment the Gift Wizard will use this information and generate a list of key search words or search terms. It will then search the Gift Universe (as described in further detail hereinbelow) to find items (products and services) having descriptions matching these words or terms. This can be done by matching meta-tags for items in the Gift Universe. Items or services having matching terms are then ranked in order of preference with those items or services having more words or terms matched being ranked higher. The Gift Wizard will then display the top five or ten items on this list.

In a preferred embodiment, the Wizard List will display some brief information about each item including the item name/description, the item brand or manufacturer/retailer, the price for the item. It will also display a link to the item where it can be directly added to the “Action Runner” for future purchase upon occurrence of an action event.

As further shown in FIG. 5, a user can then utilize further features of the present invention to then narrow down the list of items which appears on the Wizard List utilizing and selecting any one or more of several selection criteria including a price limit criteria, a gift type criteria, a holiday type criteria, and a closest match criteria. For example, a user could narrow the list to include only items priced at a certain dollar amount or less (such as $10 or less). Alternatively, a user might wish to only display electronic items or items which have only received a user rating of three or more stars.

The Gift Wizard and the Action Runner allow a user to tie gift giving to an action event to automate the entire process. For example if a user is going out of town for business for the entire month of December has 14 people scheduled to receive holiday gifts in December, the user can set the “Action Runner” to allow the “Gift Wizard” to select the gifts for each of these users upon occurrence of an Action Event. As explained earlier, the user can specify any date upon which each of these gifts are to be purchased and shipped. Moreover, when the user sets up the Action Event he/she can elect to utilize the Gift Wizard to fully execute the process. In doing so, the user can specify a specific dollar budget for each gift, a particular item type (such as electronics item, a video, or an article of clothing). Then when each action event is reached the “Gift Wizard” can select an appropriate gift which has been specially selected by the Gift Wizard for the other user to whom the gift is being sent which is then sent by the Action Runner, said gift being automatically selected from the Wizard List in accordance with the criteria set by the user when setting up the action item.

The “Gift Wizard” is also very useful in recurring action events and can be set to select gifts for these events. If the user wanted they could set a recurring action event to send a present to a friend on his birthday every year and have the “Gift Wizard” select this gift with a specified budget of $25. This way every year on the friend's birthday, the friend will not only receive a gift on time but it will also be a gift the friend desires. If the user desired it could have the “Gift Wizard” select a gift for this friend's birthday for the next 10 years. This would not only allow the user to be 100% worry free about this action event but also free countless hours of time while effectively delivering desired gifts on time.

Account Management—My Account

As explained earlier herein, the present invention includes an account management feature—referred to sometimes hereinafter as the “My Account” feature—which allows the user to set personal preferences, monitor all past and pending transactions, set up account funding options, set account privacy preferences and set up a “Wish List”.

Wish List Feature

The “Wish List” feature allows a user to compile a diverse list of gifts which the user desires to own/possess. Depending on that users “privacy settings”, this list may be accessible to all other users, thereby allowing other user's to use this Wish List—in concert with the Gift Wizard feature of the present invention—so that the user can receive the exact gifts wanted rather then anything randomly selected.

The “Wish List” preferably includes a feature by which items on the list can be flagged as pending when any other user has given or is planning to give an item from the list. More specifically, an item on the list which has already been purchased pending an Action Event will be labeled as “pending”. This feature prevents a user from receiving more than one of an item on their “Wish List”.

The Wish List information is also used by the “Gift Wizard” in order to get a more accurate profile of what the user likes and helps select gifts for a user if their gift list does not have any available gifts that are not pending or received. The “Wish List” will also provide a one-click function to send a thank you e-mail or cards for gifts received.

Wish Lists also have a very useful option to classify each gift the user may want for each type of event or holiday and make sub-lists (registries) for specific holidays. This feature makes for a dynamic way to categorize and organize Wish Lists for event's like weddings, anniversaries, graduations, etc.

“Bank Center”

In a preferred embodiment, the present invention further includes a “Bank Center” feature which allows a user to set up payment options for all purchases which will be made when an Action Event occurs. In a preferred embodiment, a user may pay for such gifts and services using a variety of sources including electronic banking transfers, major credit cards, and/or Paypal.

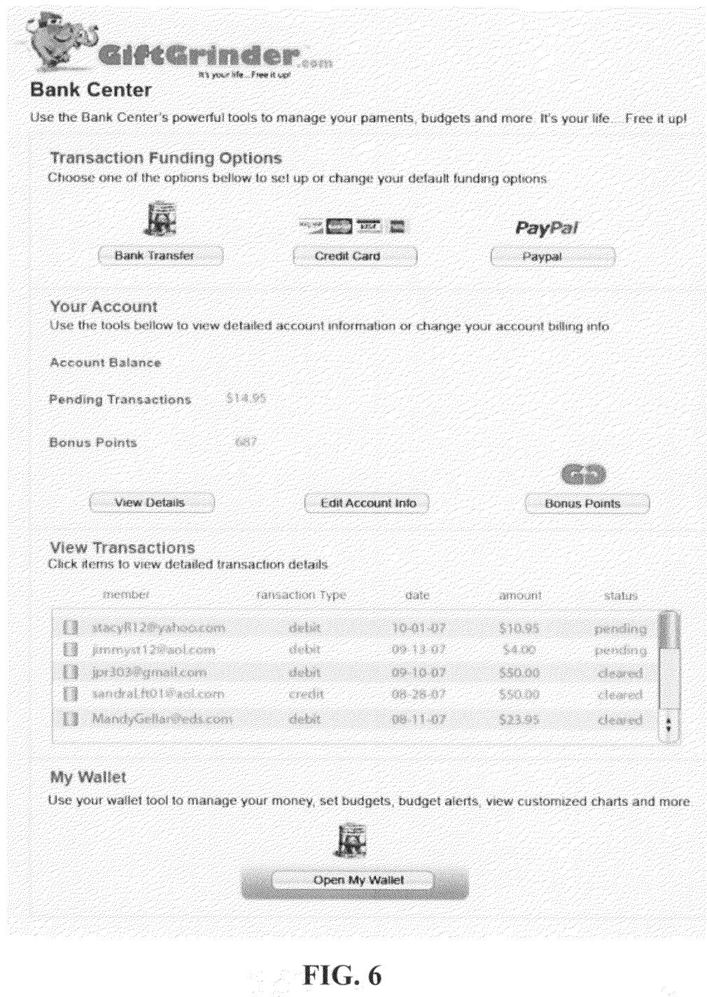

FIG. 6 illustrates a preferred embodiment for the “Bank Center” feature of the present invention. As shown, a user can set up any one of several transaction funding options including bank transfer funding, credit card funding and pay pal account funding. More specifically, a user will select the bank transfer funding option if the user which to have the automated gift giving transactions execute by the present invention to be paid by bank transfer. The user will then be prompted to enter information pertaining to his financial institution and account including the bank name, address, routing number and account number. Alternatively, if a user wishes to have the automated gift giving transactions execute by the present invention to be paid by credit card, the user will select the credit card option, where he/she will then be prompted to enter information pertaining to the credit card including the card type, the card number, the expiration date and any security code which may accompany the card.

As further shown in FIG. 6, in a preferred embodiment of the present invention the Bank Center feature an track spending over a monthly cycle and provide specific information relevant to the last few (5-10) transactions executed by the invention.

“My Wallet”—Budgeting Feature

In a preferred embodiment, the invention further includes a finance/budget feature—referred to as the “My Wallet” feature. Utilizing this feature of the software, a user may create budgets and keep track of gift expenses throughout the year. This feature can let the user budget specific events, keep track of annual gift budgets and also allows the user to set up alerts when these budgets are coming close to being exceeded.

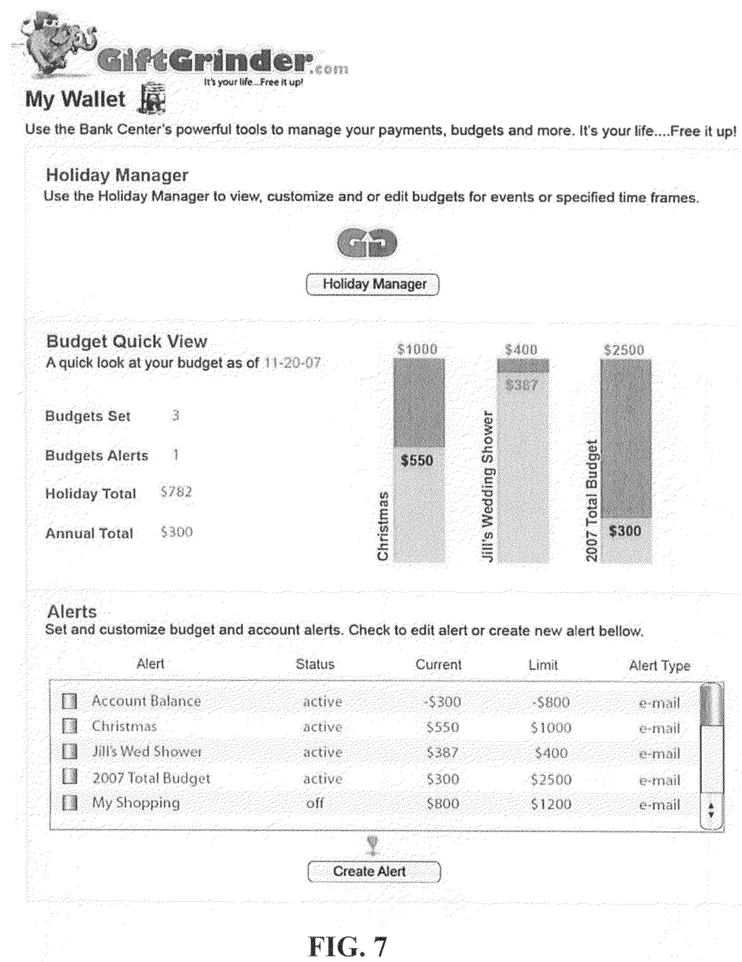

FIG. 7 illustrates the “My Wallet” budgeting feature of the present invention. As shown, this user has set up three different budget including one for Christmas gifts, one for a wedding shower, and an overall Year 2007 spending budget. The software of the present invention will automatically increase these amounts spent under each of these budgets whenever an action event having a gift purchase is executed. In this way, the software automatically tracks spending for each budget as the automated action events are executed.

“Gift Points”

Another feature of the present invention is the accumulation and use of “Gift Points”. These points are similar to frequent shopper rewards and are awarded every time an action event is executed with the purchase and shipment of a corresponding gift. These points can then be used for future purchases of any good or service, such as when sending gifts. Alternatively, a user may give points to another user for that user to use when making a purchase, much like a gift card or gift certificate.

In a preferred embodiment, a user will earn 1 “gift point” for every dollar spent on the network during his/her first year of membership. After such time, a user will preferably receive 2 points for every dollar spent on the network.

“Contacts”

The “Contacts” feature allows a user to easily and efficiently organize all their personal and professional contacts and their address/contact information. In order to enter new contact information, a user would click on the “Add Contact” link within the “Contacts” area. The user is then prompted to enter the contact's name, telephone number, e-mail address and any other relevant contact information (such a company name, an alternate phone, or an alternate e-mail). After this information is entered and submitted the invention will automatically search its registry to see if this name and or e-mail address matches up with an existing active member. If a match is found, the user will be prompted that this member is already a member and gives them an option to add this contact to their “Contacts” and also provides an option to have an e-mail sent to the contact letting them know that they have been added to the user's Contacts list. In a preferred embodiment, this optional e-mail gives the contact the option of one-click adding the user to their contacts as well (a reciprocal type of contact registration).

If a match is not found the user will be given the option to have an e-mail invitation sent to the contact, letting them know that the user has added them to their contacts and giving them a one click hyper-link that will take the contact to the register page so that contact can become a registered user of the system and invention of the present invention—so that contact can also begin using the many features of the present invention.

### “Privacy” Settings for Calendar Events

One of the main features of the present invention is setting the “Privacy” for certain events. This is actually accomplished by placing a privacy setting for each contact in the Contact's list as they are entered. This is a way to restrict or allow access to your information including calendar event sharing, wish lists and contact information. Privacy settings can be assigned to individual contacts as well as “Groups” (as defined hereinafter).

“Groups”

“Groups” is a feature within the “Contacts” menu which provides an easy way for a user to organize his or her contacts so that they can be easily accessed and tied to various events as they appear on the user's calendar. A “Group” can be assigned it's own name and privacy settings. For example a user can add all of their family and relatives into a “Group” labeled “Family” and set the options so the “Family” group will have access to all that users contact information including shipping addresses. After this group is created it can then be used with events in the calendar. For example if the user is having a birthday event on September 12^{th}, after creating this event in the “My Events” the user can allow only the contacts in the “Family” group to share this event and have it show up on their calendar as well.

Group Gift

The “Group Gift” feature is a unique and dynamic tool that allows any member to set up a specified gift that can have the cost shared by an unlimited amount of other members. The Group gift option is accessed through the Action Runner and can be assigned to any gift item and action event. In the “Group Gift” page, a user can enter separate members and or groups to be notified by e-mail of an upcoming action event having a gift purchase associated therewith. In this e-mail these other users/members are provided with a link which allows them to contribute to the purchase of a group gift. The user may contribute any amount to the gift.

The group gift feature is a fantastic way for large groups to work collectively to purchase a single more expensive gift that an individual may want or have on their wish list. The “Group Gift” info page for this transaction will be viewable by all invited to participate and will provide optional information on who contributed, the amount contributed, the goal amount and when this goal is reached. If the goal is reached the item is shipped to recipient along with many options of accompanying cards, group card or e-mail letting them know who has contributed.

If the goal has not been met by the specified time, the member who created the event will have the option of changing the gift to a lower priced item or send a gift card for the exact amount contributed.

Gift Universe

The “Gift Universe” is on-line database or shopping mall of gift products and services which may be selected for purchase. The Gift Universe provides a user access to hundreds of major retailers and boutique shops making finding or requesting that perfect gift just a click away. The “Gift Universe” has a breakdown of many popular product and service areas to quickly access a class of items. The “Gift Universe” is also searchable to help pinpoint a specific item.

In a preferred embodiment all products and services available through the Gift Universe are stored by means of a shared database which may be accessed and updated by selected retailers. More specifically, the present invention is operated independently via a server or series of servers which are accessed via the internet. Select retail providers are selected to provide dedicated links which provide access to any items or services they sell which they wish to make available through the Gift Universe. More specifically, in the Gift Universe, there are a plurality of icons displayed, each of which represents one of these selected retailers. The user may select one of these icons and is then taken to a single or multi-page display for the items available from this retailer.

Each retailer will be responsible for providing dedicated links to their current product and/or services which have been preselected for inclusion in the Gift Universe database. These links are accessed using the Gift Universe feature of the present invention. Accordingly, the actual shopping and management of all data related to products and services available through the Gift Universe are actually maintained by these third party retailers and transactions take place through their dedicated link. This however is transparent to the user of the present invention as everything is displayed through the Gift Universe.

In a preferred embodiment, all purchases, tracking, shipping and customer service will be handled by each goods and service provider. When a user selects a specific retailer by clicking on that retailer's icon or hyperlink they are then driven to the links for this retailer's available products which may be purchased from within the Gift Universe.

When a desired item is located in the “Gift Universe” it can be assigned to a “Action Event”, “Wish List” or placed in a “Favorite” basket for later use by clicking the desired option available in that products information window. When an item from the “Gift Universe” is placed in one of these categories an icon of the item and short description will appear to represent it.

### Quick Click “Gift Card Center”

The Quick Click “Gift Card Center” is a feature linked to the Gift Universe but is also viewable and available from the “Action Runner”. This feature allows a user to easily view and select from a range of “gift cards” from various retailers and apply them to action events as gifts. This not only allows for a quick and easy way to select a fast gift but also allows flexibility for the recipient to use a gift card for a wide variety on gifts that may not have been on the “Wish List”.

One can use the system and method of the present invention in order to create a shared calendar and coordinate the automatic execution of a gift giving event. Although a preferred embodiment and specific web page outlays for achieving the objectives of the present invention have been provided and described for illustrative purposes, those skilled in the art will appreciate that various modifications, additions and substitutions are possible, without departing from the spirit and scope of the invention and the invention is not intended to be limited to any one particular embodiment except as claimed.

Freedom Registry

Gift Grinder's “Freedom Registry” feature is another unique and powerful feature that breaks the mold of currently available traditional registry services. This service provides a simple and easy way for members to have total freedom and control over their gift registry process while saving them time and money in the process. In the past gift registry confined gift selection and gift giving to one limited source. With Gift Grinder's “Freedom Registry” the member has absolute freedom to choose a registry gift list from hundreds of popular and boutique sources and provide their guests a simple and easy way to deliver them. This service also provides many options including: sending custom e-mail or paper invitations, on-line RSVP and on-line or paper “thank you” cards.

As explained earlier herein, a key feature of the present invention is the ability to schedule action events tied to gift giving and then have the software of the present invention automatically execute a series of user specified gift giving instructions upon occurrence of the action event.

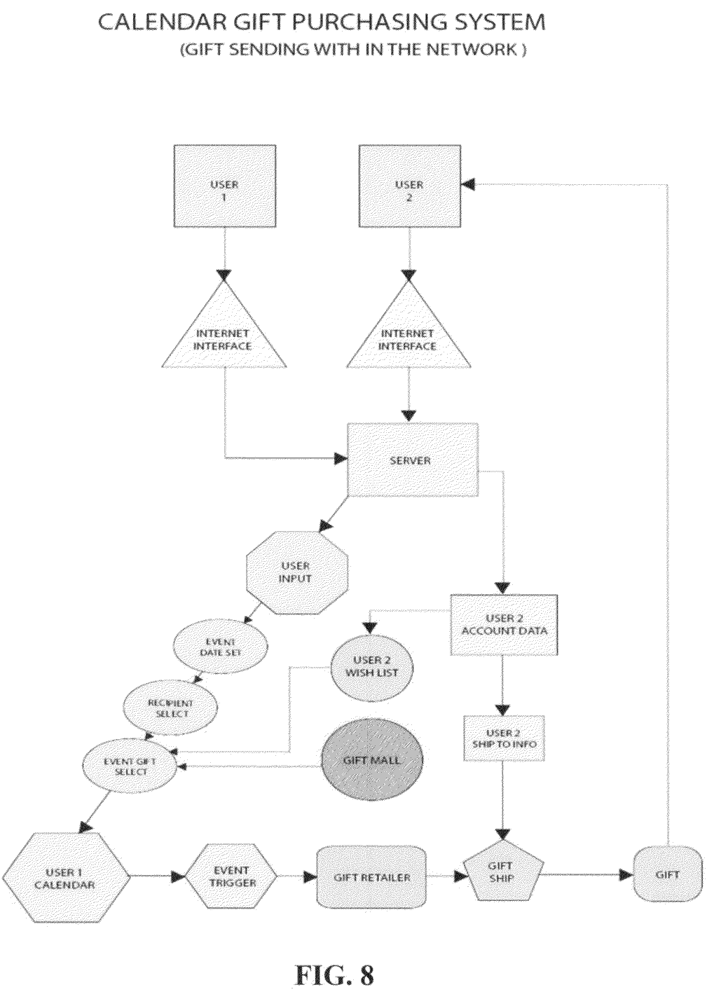

FIG. 8 illustrates a flow chart for using the software of the present invention in order to execute an automated gift giving action event. As shown in FIG. 8, there are two users to the system and each has access to a server, where the software of the present invention resides, via an internet connection and interface. In the flow chart of FIG. 8, one of the user's wishes to set up a gift giving event and have the software of the present invention then automatically execute a series of gift giving instructions upon occurrence of this event—perhaps it is the other user's birthday.

As shown in FIG. 8, one of the user will input information for the action event, as specified herein earlier, including the event name, the event date and a recipient of the gift with which the gift giving action event is associated. The user will also select a gift to be sent upon occurrence of the associated date. This gift may be selected from the gift universe/mall of available gifts or it may be selected from the other user's wish list. As stated herein earlier, the user may specify the gift to be purchased and shipped or he/she may utilize the Gift Wizard of the present invention. If the user decides to utilize the Gift Wizard then he or she may simply specify a gift amount and the Wizard will automatically select the gift either from the intended recipient's Wish List or from the Gift Universe/mall.

The action event is then placed on the user's calendar. When the action date occurs, it will trigger the automatic execution of the action and the software will then automatically execute the gift giving process. The software will purchase the gift from the appropriate retailer, using the payment information provided by the user. The software will also automatically provide the retailer with the address associated with the user (in this case User2) where the gift is to be shipped. Since the intended recipient is also a user of the system, this shipping address is pulled directly from information provided by that user—typically provided by that user at the time he/she set up their individual user account). The retailer will then automatically ship the purchased gift to the recipient (again in this case User2).

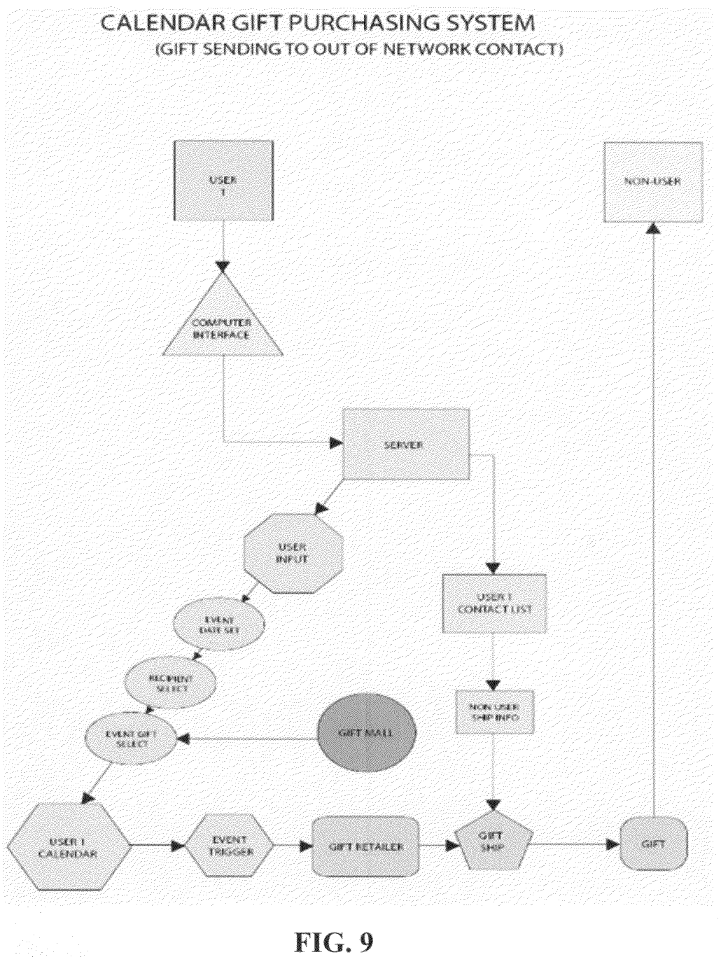

FIG. 9 illustrates an alternate flow chart for using the software of the present invention in order to execute an automated gift giving action event. As shown in FIG. 9, the intended recipient is not a user to the system. Accordingly, unlike the flowchard in FIG. 8, this flowchart shows the steps for executing a gift giving action event associated with a non-user recipient. As shown in the flow chart of FIG. 9, a first user wishes to set up a gift giving event and have the software of the present invention then automatically execute a series of gift giving instructions upon occurrence of this event.

Referring still to FIG. 9, the user will input information for the action event, as specified herein earlier, including the event name, the event date and a recipient of the gift with which the gift giving action event is associated. In this case the recipient is selected from the user's contacts by the user and is not a fellow user to the system. Therefore this person will not have a Wish List.

The user will then select a gift to be sent upon occurrence of the associated date. Since the recipient is not a user to the system, this gift must be selected from the gift universe/mall of available gifts. However, when setting up this action even, the user still has the option of either specifying the exact gift to be purchased and shipped or he/she may utilize the Gift Wizard of the present invention. If the user decides to utilize the Gift Wizard then he or she may simply specify a gift amount and the Wizard will automatically select the gift either from the Gift Universe/mall.

As further illustrated in FIG. 9, the action event is then placed on the user's calendar. When the action date occurs, it will trigger the automatic execution of the action and the software will then automatically execute the gift giving process. The software will purchase the gift from the appropriate retailer, using the payment information provided by the user. The software will also automatically provide the retailer with the address associated with the user (in this case User2) where the gift is to be shipped. Since the intended recipient is not a user of the system, this shipping address is pulled directly from the user's contact information for the intended recipient—typically provided by the user at the time he/she set up his or her individual user account). The retailer will then automatically ship the purchased gift to the recipient.

Although preferred embodiments of this invention have been described above with a certain degree of particularity, those skilled in the art could make numerous alterations to the disclosed embodiments without departing from the spirit or scope of this invention. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. An electronic shared calendaring system comprising:
an electronic calendar shared amongst a group of users which may be accessed by each individual user via the internet;
an event originator which allows a user to calendar any event on the shared calendar and specify privacy settings for the event, thereby controlling the visibility of the event by other users in the group having access to the shared calendar via the internet; and
an action runner which allows a user to further specify a series of instructions which are to be automatically executed by the system upon occurrence of an event on the shared calendar.

2. The shared calendar system of claim 1, wherein the series of instructions which are to be automatically executed include the automated purchase and shipment of a gift.

3. The shared calendar system of claim 2, wherein the series of instructions include specification of a gift limit amount for the gift to be purchased and shipped, and an specification of an intended recipient.

4. The shared calendar system of claim 3, wherein the gift purchased and shipped is automatically selected from a Wish List set up by the intended recipient based upon the gift limit amount previously specified by the user.

5. The shared calendar system of claim 3, wherein the gift to be purchased and shipped is automatically selected from a plurality of available gifts based upon demographic information pertaining to the intended recipient and the gift limit amount previously specified by the user.

6. The shared calendar system of claim 5, wherein the system will generate a list of search words or terms based upon the demographic information and will then search meta tags associated with each of the available gifts in the plurality in order to select one for purchase.

7. A system for automating a gift giving process comprising:
an electronic calendar shared over the internet which may be accessed by a plurality of users;
an action event component which allows anyone of the plurality of users to place a gift giving event on the electronic calendar and to further specify a series of instructions which will be automatically executed upon occurrence of the gift giving event;
a gift wizard component which automatically execute the series of instructions upon occurrence of the gift giving event.

8. The system of claim 7, wherein the series of instructions which will automatically be executed upon occurrence of the gift giving event include the automated purchase and shipment of a gift.

9. The system of claim 7, wherein the series of instructions which will automatically be executed upon occurrence of the gift giving event include the automated purchase and shipment of an electronic greeting card.

10. The system of claim 8, wherein the action event component allows a user to specify a gift limit amount for the gift to be purchased and shipped, and an intended recipient.

11. The system of claim 10, wherein the gift to be purchased and shipped is automatically selected by the gift wizard component from a plurality of available gifts based upon demographic information pertaining to the intended recipient and the gift limit amount previously specified by the user.

12. The system of claim 11, wherein the system will generate a list of search words or terms based upon the demographic information and will then search meta tags associated with each of the available gifts in the plurality in order to select one for purchase.

13. A method for sharing calendar information via the internet among a plurality of users, said method comprising:
providing a shared calendar interface which provides a monthly calendar having at least one event specified therein, said event having a privacy setting which controls the visibility of the event by any one user in the plurality having access to the shared calendar; and
specifying a series of instructions which is to be automatically executed by a computer system upon occurrence of the at least one event on the shared calendar.

14. The method of claim 13, wherein the step of specifying a series of instructions further includes the steps of setting up parameters for the automated purchase and shipment of a gift.

15. The method of claim 14, wherein the parameters for the automated purchase and shipment of a gift include a gift limit amount for the gift to be purchased and shipped, and an intended recipient.

16. The method of claim 15 wherein the gift to be purchased and shipped is automatically selected when the instructions are executed, said selection being based upon demographic information pertaining to the intended recipient and the gift limit amount previously specified by the user.

17. The method of claim 16, further comprising the steps of:
generating a list of search words or terms based upon the demographic information, and
searching through meta tags associated with each of the available gifts in the plurality;
determining a match between any words or terms in the list and any of the meta tages; and
selecting a gift for purchase and shipment based upon a number of matches determined for that gift.

18. Software for receiving and providing shared calendar information to multiple users, said software comprising:
a shared calendar interface which may be accessed via a wide area network;
an event originator which allows a user to calendar any event on the shared calendar and specify privacy settings for the event, thereby controlling the visibility of the event by other users in the group having access to the shared calendar interface; and
an action runner which allows a user to specify a series of instructions which are to be automatically executed by the software upon occurrence of a date related to the event the user has placed on the shared calendar.

19. The software of claim 18, wherein the series of instructions which are to be automatically executed include the automated purchase, over the internet, of a gift for an intended recipient.

20. The software of claim 19, wherein the gift purchased and shipped is automatically selected from a Wish List previously specified by the intended recipient.

21. Software for automating a gift giving process comprising:
an electronic calendar shared over the internet which may be accessed by a plurality of users;
an action event component which allows anyone of the plurality of users to place a gift giving event on the electronic calendar and to further specify a series of instructions which will be automatically executed by the software upon occurrence of the gift giving event;
a gift wizard component which will automatically execute the series of instructions upon occurrence of the gift giving event.

22. The software of claim 21, wherein series of instructions which will automatically be executed by the software upon occurrence of the gift giving event include the automated purchase and shipment of a gift.

23. The software of claim 21, wherein series of instructions which will automatically be executed by the software upon occurrence of the gift giving event include the automated purchase and shipment of an electronic greeting card.

24. The software of claim 22, wherein the action event component allows a user to specify a gift limit amount for the gift to be purchased and shipped, and an intended recipient.

25. The software of claim 24, wherein the gift to be purchased and shipped is automatically selected by the gift wizard component from a plurality of available gifts based upon demographic information pertaining to the intended recipient and the gift limit amount previously specified by the user.

26. The software of claim 25, wherein the software will generate a list of search words or terms based upon the demographic information and will then search meta tags associated with each of the available gifts in the plurality in order to select one for purchase and shipping.
